(19) United States
(12) Patent Application Publication
(10) Pub. No.: US 2021/0295287 A1
(43) Pub. Date: Sep. 23, 2021

(54) FUND ASSIGNMENT FOR ROUND-UP TRANSACTION

(71) Applicant: Hedge, Inc., Pittsburgh, PA (US)

(72) Inventors: Jackson Fitzgerald, Pittsburgh, PA (US); Justin Matsnev, Holland, PA (US); Mitchell Malinin, Boca Raton, FL (US)

(21) Appl. No.: 16/825,457

(22) Filed: Mar. 20, 2020

(51) Int. Cl. G06Q 20/10; G07F 17/32

(52) U.S. Cl. CPC G06Q 20/102; G07F 17/3244; G07F 17/3288

(57) ABSTRACT

One embodiment provides a method, including: receiving an indication of a purchase transaction by a user, wherein the purchase transaction comprises a purchase by the user from a retail entity and wherein the transaction is associated with a financial institution of the user; transferring a predetermined monetary amount from the financial institution to an deposit entity, wherein the transferring comprises conducting a round-up transaction corresponding to the predetermined monetary amount and in conjunction with the purchase transaction; and assigning the predetermined monetary amount to one of a plurality of funds within the deposit entity, wherein the plurality of funds are chosen by the user and wherein the one of the plurality of funds is variable between purchase transactions. Other aspects are described and claimed.

### BACKGROUND

A round-up transaction is a transaction that is conducted in conjunction with a purchase transaction. The round-up transaction, as the name suggests, causes the total monetary amount of the purchase transaction to be rounded up to a whole number or a set value. For example, a user may set the round up value to be the next nearest whole dollar. Accordingly, when the user makes a purchase costing $4.98, the round-up transaction would be $0.02, causing the total monetary transaction amount to be equal to $5.00. As another example, when the user makes a purchase costing $7.13, the round-up transaction would be $0.87, causing the total monetary transaction amount to be $8.00. Other round up increments may be used, for example, the next nearest half-dollar, the next nearest tenth of a dollar, or the like. The money associated with the round-up transaction is then sent to a predetermined account, for example, a savings account, an investment account, or the like. Accordingly, the use of round-up transactions is becoming increasingly popular, particularly to help users save money. While each round-up transaction may be small, the aggregate of the round-up transactions over time add up to a larger pool of money.

### BRIEF SUMMARY

In summary, one aspect provides a method comprising: receiving an indication of a purchase transaction by a user, wherein the purchase transaction comprises a purchase by the user from a retail entity and wherein the transaction is associated with a financial institution of the user; transferring a predetermined monetary amount from the financial institution to an deposit entity, wherein the transferring comprises conducting a round-up transaction corresponding to the predetermined monetary amount and in conjunction with the purchase transaction; and assigning the predetermined monetary amount to one of a plurality of funds within the deposit entity, wherein the plurality of funds are chosen by the user and wherein the one of the plurality of funds is variable between purchase transactions.

Another aspect provides a system, comprising: a processor; a memory device that stores instructions executable by the processor to: receive an indication of a purchase transaction by a user, wherein the purchase transaction comprises a purchase by the user from a retail entity and wherein the transaction is associated with a financial institution of the user; transfer a predetermined monetary amount from the financial institution to an deposit entity, wherein the transferring comprises conducting a round-up transaction corresponding to the predetermined monetary amount and in conjunction with the purchase transaction; and assign the predetermined monetary amount to one of a plurality of funds within the deposit entity, wherein the plurality of funds are chosen by the user and wherein the one of the plurality of funds is variable between purchase transactions.

A further aspect provides a product, comprising: a storage device that stores code, the code being executable by a processor and comprising: code that receives an indication of a purchase transaction by a user, wherein the purchase transaction comprises a purchase by the user from a retail entity and wherein the transaction is associated with a financial institution of the user; code that transfers a predetermined monetary amount from the financial institution to an deposit entity, wherein the transferring comprises conducting a round-up transaction corresponding to the predetermined monetary amount and in conjunction with the purchase transaction; and code that assigns the predetermined monetary amount to one of a plurality of funds within the deposit entity, wherein the plurality of funds are chosen by the user and wherein the one of the plurality of funds is variable between purchase transactions.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates a method for assigning a predetermined monetary amount associated with a round-up transaction to one of a plurality of funds within a deposit entity based upon user input, where the chosen fund is variable between round-up transactions.

FIG. 2 illustrates an example user interface for a deposit entity having a plurality of selectable funds.

FIG. 3 illustrates an example user interface for a deposit entity fund selection based upon a monetary multiplier.

FIG. 4 illustrates an example of device circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

To make a round-up transaction seamless, the purchase transaction is usually made with some mechanism that causes an electronic transfer or hold of money from an account of a user. In other words, the purchase transaction is usually completed using a credit card, debit card, or virtual payment mechanism (e.g., virtual wallet, online payment system, etc.). The use of the electronic transfer medium allows for the inclusion of a second transaction created in conjunction with the purchase transaction, the second transaction being the round-up transaction. In other words, utilizing the electronic transfer medium allows for programming of code that triggers a secondary transaction on top of every purchase transaction, which is not really supported using paper mediums like checks, money orders, or the like.

The advantage of round-up transactions is that it allows the user to make transactions with small amounts of money when generally transactions of this monetary size would not be supported. The ability to make round-up transactions is generally provided by a bank or other banking institution providing both user accounts debit or credit cards. The bank performing the round-up transaction is the least complex version of the round-up transaction. In this scenario, whenever the user uses the credit or debit card, or other electronic medium, associated with the bank, the bank also transfer the amount of the round-up transaction to another account within the bank and associated with the user. For example, if a user uses a debit card associated with a checking account, the round-up amount may be transferred from the user's checking account to the user's savings account within the bank. The thought is that by allowing users to transfer small amount of money at a time, the user will save money that would not have been saved and, since it is a small amount at a time, the user will not “miss” the money for spending, thereby encouraging long term savings.

Since round-up transactions are actually treated as separate transactions, the round-up transaction technique can be employed by entities other than the bank or entity associated with the purchasing payment medium, referred to as third-party or deposit entities. One of these types of round-up transactions is common with retailers. If a user approves a round-up transaction, the retailer will include a second, round-up transaction, on top of the purchase transaction. This round-up transaction is usually a donation to a charity, but could be to any entity. Another type of deposit entity round-up transaction is associated with an investment entity. The investment entity receives the amount associated with the round-up transaction and invests it into a predetermined investment fund or investment account on behalf of the user making the purchase. This allows the user to make investments even with small amount of money at a time, with the thought that this will encourage investing.

The problem with current round-up techniques is that the money associated with the round-up transaction is transferred to a single, predetermined fund or account. In the case of the banking institutions, the round-up transaction amount is sent to a single account that cannot be varied with different round-up transactions. In order for a user to send the round-up transaction amount to a different account, the user either has to set up different round-up transaction accounts with different electronic payment mediums (e.g., debit card, credit card, virtual wallet, online payment service, etc.) or manually change the account that the round-up amount is transferred to. The problem with the first technique is that the user cannot use the same electronic payment medium for all purchasing transactions and must keep track of which electronic payment medium is associated with which round-up transaction account. A problem with the second technique is that this requires a manual change and the change is effectuated for all purchasing transactions until another manual change is instigated, usually through the bank. Thus, the change cannot be made in real-time or at the time a purchase transaction is made.

Similar problems are present with third-party or deposit entities. With the retailer the fund or recipient of the round-up transaction amount is preset and cannot be changed. Accordingly, while the user may have donated to one charity, the user may not donate to another charity. Thus, since the user cannot select what charity the round-up transaction amount is transferred to, the user may not make any donation at all. With the investment entity, the round-up transaction amount is sent to a predetermined or preselected investment fund or account. The user cannot select which investment fund or stock the round-up transaction amount is invested into at the time of the purchase. Thus, while the investment fund may include a few different stocks or investment options, the entirety of the round-up transaction amount is provided into the same investment fund with no control by the user on which stock or investment option the round-up transaction amount is actually invested into.

Accordingly, an embodiment provides a method for assigning a predetermined monetary amount associated with a round-up transaction to one of a plurality of funds within a deposit entity based upon user input, where the chosen fund is variable between round-up transactions. The system, associated with a deposit entity, receives an indication of a purchase transaction by a user. The purchase transaction is a transaction initiated with a retailer, for example, a brick-and-mortar store, online retailer, services provider, or the like. In initiating this purchase transaction, the user employs a financial institution associated with the user (e.g., a bank, a credit card provider, an online payment services provider, etc.). In conjunction with the purchase transaction, the deposit entity initiates a transfer of a predetermined monetary amount from the financial institution to the deposit entity. This predetermined monetary amount corresponds to the value of a round-up transaction.

Upon receiving the round-up transaction amount, the deposit entity assigns the monetary amount to one of a plurality of funds within the deposit entity. The funds are chosen by the user and the selected fund is variable between transactions. In other words, the selected fund does not have to be same upon receipt of each round-up transaction. Rather, upon receiving the round-up transaction amount, the deposit entity may provide a user interface requesting the user select a fund for the round-up transaction amount to be assigned to. Upon receiving a user selection, the deposit entity assigns the round-up transaction amount to the selected fund. The user may also select multiple funds for the round-up transaction amount to be split up among. Alternatively, the deposit entity may assign the round-up transaction amount to a holding fund. Upon the user accessing the deposit entity (e.g., opening an application associated with the deposit entity, accessing an online portal associated with the deposit entity, providing a text message or other communication to the deposit entity, etc.), the deposit entity may request the user identify how the round-up transaction amount should be treated or to which fund it should be transferred or assigned.

Such a system provides a technical improvement to current round-up transaction performance. The described system and method provide a technique that allows a user to direct the round-up transaction to a particular fund within a deposit entity. Thus, instead of being tied to a single fund or account as with conventional techniques, the user has the freedom to choose what fund is funded at the time the round-up transaction is generated. The user can then vary the selected fund with each round-up transaction and is not tied to a single fund, thereby giving the user control over how the round-up transaction money is utilized. Additionally, since the described system and method provides an application and user interface, the user can make fund selections as soon as the round-up transaction is provided to the deposit entity, thereby eliminating conventional fund selection techniques that require the user to call or otherwise contact the deposit entity to have the fund changed and then all subsequent round-up transactions being treated the same way. Thus, the described system and method provides more flexibility to a user than the conventional round-up transaction performance techniques.

The illustrated example embodiments will be best understood by reference to the figures. The following description is intended only by way of example, and simply illustrates certain example embodiments.

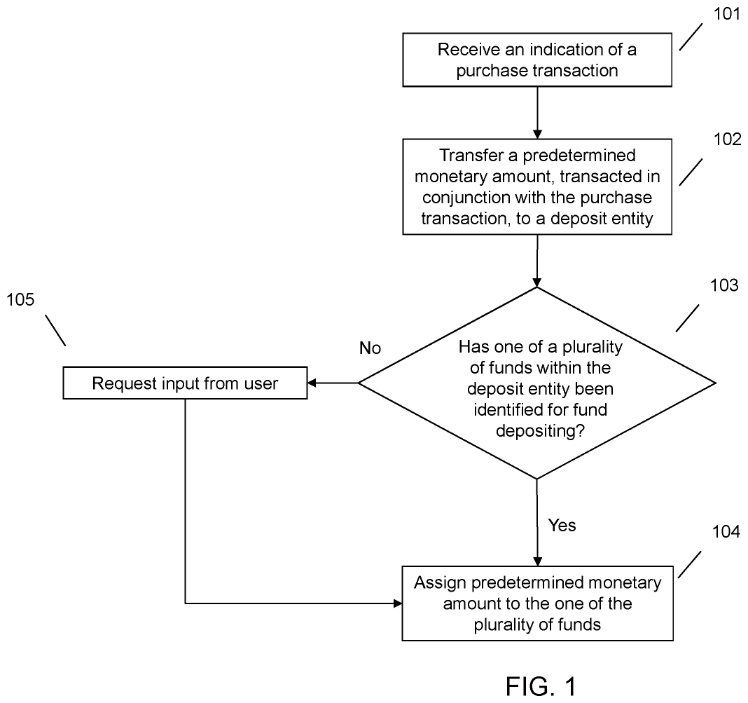

FIG. 1 illustrates a method for assigning a predetermined monetary amount associated with a round-up transaction to one of a plurality of funds within a deposit entity based upon user input, where the chosen fund is variable between round-up transactions. At 101 the system receives an indication of a purchase transaction by a user where the purchase is associated with a purchasing or retail entity (e.g., brick-and-mortar retailer, online retailer, services provider, etc.). The indication is received at a system of a deposit entity. The term deposit entity refers to the entity that a monetary amount is transferred to in conjunction with a round-up transaction, as discussed further herein.

The user pre-establishes a relationship between the deposit entity and an electronic payment medium or method (e.g., credit card, debit card, online payment provider, etc.). Generally the technique for establishing this relationship is that the user accesses the deposit entity, for example, via a website, application of the deposit entity, or the like, and then provides the deposit entity with information associated with the electronic payment medium (e.g., card number, expiration date, name, address, etc.). The deposit entity can then access the electronic payment medium and monitor the payment medium for the initiation of a purchase transaction. Conversely, in establishing the relationship, the user may access the electronic payment medium provider and connect the electronic payment medium and the deposit entity through the payment provider.

In establishing the relationship between the deposit entity and payment medium, the user gives the deposit entity access to the electronic payment medium, at least to the extent that the deposit entity can determine when a purchase is made and the amount of the purchase. The deposit entity may receive additional information regarding the retailer, geographical location, items/services purchased, or the like. However, the deposit entity generally only utilizes the fact that a purchase was made and identification of an amount of the purchase, unless a user indicates that additional steps should be performed by the deposit entity with respect to the purchase transaction.

Due to the established relationship between the deposit entity and the electronic payment medium, when the user makes a purchase at a retail entity, a system of the deposit entity can receive an indication of the purchase. For example, the system can listen for a purchase trigger. Responsive to receiving the indication of the purchase, the deposit entity can initiate the round-up transaction. Thus, at 102, the deposit entity initiates a transfer of a predetermined monetary amount from the financial institution corresponding to the electronic payment medium to the deposit entity. The predetermined monetary amount is the amount corresponding to a round-up transaction. In other words, the deposit entity conducts or initiates a round-up transaction in conjunction with the purchase transaction.

In practice, the actual transfer of money from the financial institution to the deposit entity may not occur until a threshold amount of round-up money has been reached. For example, the transfer may not occur until $5.00 worth of round-up transactions has been accumulated. Once the threshold is met, the deposit entity may initiate the transfer of funds from the financial institution. In a situation where the transfer does not occur until a threshold is met, the deposit entity may credit a user's account with the round-up transaction amounts. Thus, when the user logs into or otherwise accesses the deposit entity, the user may see that the round-up transactions have been associated with the correct fund or the user's account. Once the threshold is met, then the deposit entity will initiate the transfer. In the event that the user uses the round-up transactions amounts before the threshold is met and then cancels or otherwise stops the round-up transactions from occurring or fails to reach the threshold amount in a predetermined time period, the deposit entity may initiate a transfer of funds from the financial institution to cover the used round-up transaction amount. Whether the round-up transactions are initiated with every purchase transaction or only when a threshold amount is reached may be based in part upon fees charged by financial institutions for transfers.

The round-up amount is a predetermined amount in the sense that how the purchase transaction amount will be increased is preset. However, the actual amount of the round-up transaction varies between purchase transactions. For example, the user may set the round-up transaction to round up to the nearest whole dollar. Thus, in a transaction ending in $0.52, the round-up amount would be $0.48, whereas in a transaction ending in $0.03, the round-up amount would be $0.97. As another example, the user may set the round-up transaction to round up to the nearest half dollar. Thus, in a transaction ending in $0.57, the round-up amount would be $0.43, whereas in a transaction ending in $0.27, the round-up amount would be $0.23. The round-up preset may be one of many different round-up techniques, for example, rounding up a percentage of the purchase transaction, rounding up to a particular dollar amount, a set amount for every transaction regardless of the purchase transaction amount, or the like.

In initiating a round-up transaction, the system may first request a confirmation from the user. For example, the deposit entity may initiate the round-up transaction and before completing the round-up transaction may request the user confirm that the user wants to complete the round-up transaction. If the user confirms the request, then the deposit entity will continue with the round-up transaction. In the event that the user denies the request, the deposit entity will stop the round-up transaction and will not make a transfer of the monetary amount from the financial entity. Whether the system first requests a user confirmation may be set by the user. For example, some users may want the system to request confirmation for every transaction, other users may want the system to request confirmation for every transaction above a predetermined amount, and other users may not want the system to request confirmation at all.

Once the predetermined monetary amount has been transferred, the system may determine whether one of a plurality of funds within the deposit entity has been identified for fund depositing at 103. The deposit entity may have a plurality of funds within the deposit entity. Any of the plurality of funds may be utilized for the round-up transaction and the fund that is utilized can vary between purchase transactions. The user may select the plurality of funds that can be used for assignment of the round-up transaction amount. For example, the deposit entity may include twenty possible funds and the user may select five of those funds as possible funds for assignment of the round-up transaction amount. To determine whether one or more of the funds has been designated for fund depositing, the system may access a profile for the user. The user may identify within the profile how the round-up transaction amount should be treated, for example, which fund or funds to deposit the round-up transaction amount into.

The designation may be more complicated than strictly picking a single fund. For example, the user may identify that round-up transactions of a certain amount should be assigned to one fund, while round-up transactions of different amounts should be assigned to a different fund. As another example, the user may identify that round-up transactions associated with purchases from a certain retailer or retailer type should be assigned to one fund, whereas round-up transactions associated with purchases from a different retailer or retailer type should be assigned to a different fund. Additionally, the user may designate more than one fund and designate a percentage of the round-up transaction, a specific amount of the round-up transaction, or the like, should be assigned to each designated fund. The system may also confirm with the user that a pre-identified fund should be used for fund depositing, for example, by providing a pop-up window or other display to the user within an application associated with the deposit entity, by sending a communication (e.g., text message, instant message, phone call, email, etc.) to the user, or the like.

The fund designation may also occur at the time the round-up transaction is initiated by or transferred to the deposit entity. In this scenario, the system may request input from the user at 105. For example, the system may provide a pop-up window or other display within an application associated with the deposit entity, by sending a communication to the user, or the like. If a specific fund has not been specified or identified, the system may also send the round-up transaction to a holding fund. The holding fund is designed to hold the funds until either a user specifies a fund that the funds within the holding fund should be transferred into. In other words, the holding fund is like an escrow fund. The holding fund may also be used to hold funds until a predetermined monetary amount is reached within the holding fund. This monetary amount threshold may be set by the user. Upon reaching the monetary amount threshold, the system may perform an action identified by the user, for example, move the funds within the holding fund to a predetermined fund or funds, notify the user that the amount has been reached, or the like.

Once the user identifies a fund for fund depositing, either as determined at 103 or as specified by the user at 105, the system may then assign the predetermined monetary amount to the designated fund or funds, in the manner designated by the user at 104. One of the unique features of the described system is the ability to change which fund the round-up transaction amount is assigned to upon receipt of each round-up transaction. In other words, the user is not tied to a particular fund for designation of the round-up transaction as in conventional systems. For example, the system may request the user select a fund upon receipt of each round-up transaction within a user interface that is displayed in response to receiving the round-up transaction amount at the deposit entity. As another example, the user may designate a rotation of funds and the system may then assign the round-up transactions to the designated funds in the rotation. Other techniques for changing funds are possible and contemplated.

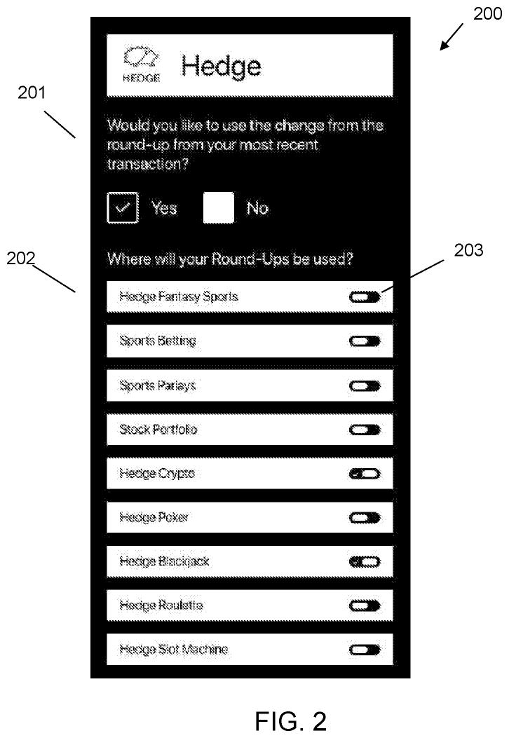

As an overall example of the described system, an embodiment will now be described. It should be understood that this is merely an example and used for illustration as the described system and method is not only applicable in the described example application. In this example application the deposit entity is a betting entity, for example, an entity that allows for betting on different games or sports. FIG. 2 illustrates an example user interface 200 that may be utilized in such an application. Upon accessing the deposit entity application, the user may be presented with the user interface and the user may be asked if the round-up transaction amount should be utilized for a transaction within the application 201. As shown in FIG. 2, the deposit entity may have many different funds 202 each corresponding to a game that can be played within the application, for example, a fantasy sports fund, sports betting fund, sports parlays fund, stock portfolio fund, crypto-currency fund, poker fund, blackjack fund, roulette fund, slot machine fund, or the like. The user may select which of the funds is used for fund designation, for example, using the toggle switch 203.

Upon selection or designation of a game, the system may use the round-up transaction amount to place a bet within the game. For example, if the user selects the blackjack game, the system may play a hand of blackjack using the round-up transaction amount as the bet for the hand. Playing the game may include displaying the game within an application of the deposit entity. Once the hand or game has been played, the application may display the outcome of the game. In other words, the application may indicate whether the user has won or lost the game. In the case of winning, the user may receive an additional monetary amount associated with odds of the game. In other words, the user may win an amount as if the user were playing the game at a traditional gambling location. As an example, if the user places a bet within a roulette application on “red” and “red” hits, the user may receive a return of an amount equal to the bet amount, thus, doubling the user's money, because the designated odds are 1:1. This amount may then be deposited into an account of the user. The user can then withdraw the money or use it to play additional games.

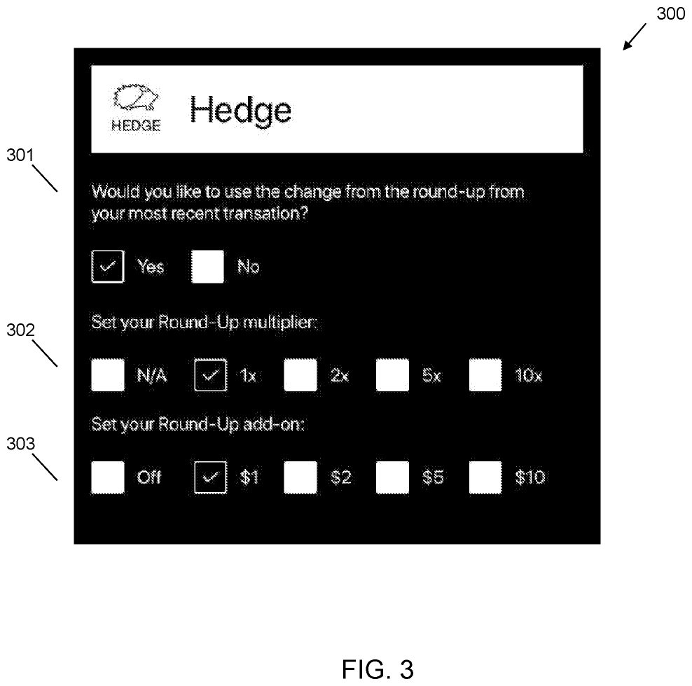

Selection of a fund or a game may be based upon a level of risk that the user selects. FIG. 3 illustrates an example user interface 300 that may be presented for a user selecting a fund based upon risk. Again, the user may be presented with the user interface and the user may be asked if the round-up transaction amount should be utilized for a transaction within the application 301. The user may then be presented with a request to select a round-up multiplier 302. This multiplier is associated with a risk or odds of a game. This is referred to as a multiplier because it identifies an amount that the bet amount could be multiplied by and is dependent on the odds of a particular game. Using the roulette “red” example, the multiplier would be a “1×” multiplier. Depending on the chosen multiplier, different games or bets may be placed. The user can also select whether the user wants to include an additional amount with the round-up transaction amount 303. This amount may be taken from a fund of the user within the application or may be withdrawn from a banking or other financial institution account associated with the application.

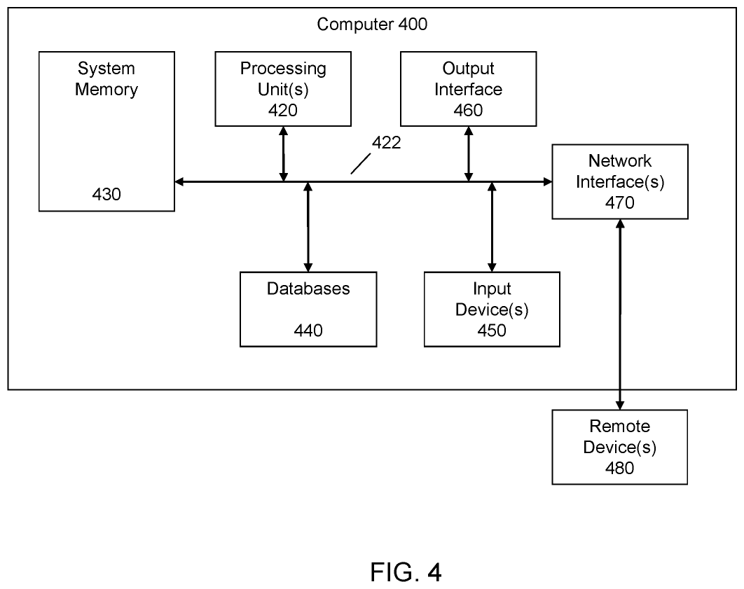

While various other circuits, circuitry or components may be utilized in information handling devices, with a computer, server, client device or the like, an example device that may be used in implementing one or more embodiments includes a computing device in the form of a computer 400 as illustrated in FIG. 4. This example device may be a server used in one of the systems in a network, or one of the remote computers connected to the network. Components of computer 400 may include, but are not limited to, a processing unit 420, a system memory 430, and a system bus 422 that couples various system components including the system memory 430 to the processing unit 420. Computer 400 may include or have access to a variety of computer readable media, including databases. The system memory 430 may include non-signal computer readable storage media, for example in the form of volatile and/or nonvolatile memory such as read only memory (ROM) and/or random access memory (RAM). By way of example, and not limitation, system memory 430 may also include an operating system, application programs, other program modules, and program data.

A user can interface with (for example, enter commands and information) the computer 400 through input devices 450 (e.g., keyboard, soft keyboard, mouse, auditory inputs, haptic inputs, gesture inputs, etc.). A monitor or other type of device can also be connected to the system bus 422 via an interface, such as an output interface 460. The computer may include a database 440. In addition to a monitor, computers may also include other peripheral output devices. The computer 400 may operate in a networked or distributed environment using logical connections to one or more other remote device(s) 480 such as other computers. The logical connections may include network interface(s) 470 to a network, such as a local area network (LAN), a wide area network (WAN), and/or a global computer network, but may also include other networks/buses.

Information handling device circuitry, as for example outlined in FIG. 4, may be used in client devices such as a personal desktop computer, a laptop computer, or smaller devices such as a tablet or a smart phone. In the latter cases, i.e., for a tablet computer and a smart phone, the circuitry outlined in FIG. 4 may be adapted to a system on chip type circuitry. The device, irrespective of the circuitry provided, may provide and receive data to/from another device, e.g., a server or system that coordinates with various other systems. As will be appreciated by one having ordinary skill in the art, other circuitry or additional circuitry from that outlined in the example of FIG. 4 may be employed in various electronic devices that are used in whole or in part to implement the systems, methods and products of the various embodiments described herein.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method comprising:
receiving an indication of a purchase transaction by a user, wherein the purchase transaction comprises a purchase by the user from a retail entity and wherein the transaction is associated with a financial institution of the user;
transferring a predetermined monetary amount from the financial institution to an deposit entity, wherein the transferring comprises conducting a round-up transaction corresponding to the predetermined monetary amount and in conjunction with the purchase transaction; and
assigning the predetermined monetary amount to one of a plurality of funds within the deposit entity, wherein the plurality of funds are chosen by the user and wherein the one of the plurality of funds is variable between purchase transactions.

2. The method of claim 1, wherein the predetermined monetary amount is determined based upon a monetary amount of the purchase transaction.

3. The method of claim 1, wherein the one of the plurality of funds is selected based upon an amount of risk identified by the user.

4. The method of claim 1, wherein each of the plurality of funds corresponds to a game played using the predetermined monetary amount.

5. The method of claim 4, wherein the game comprises a betting game and wherein playing the game comprises placing a bet utilizing the predetermined monetary amount within the betting game.

6. The method of claim 5, wherein the game is played upon receipt of the predetermined monetary amount and displayed within an application associated with the deposit entity.

7. The method of claim 6, comprising displaying an outcome of the played game.

8. The method of claim 1, wherein the deposit entity comprises a betting entity.

9. The method of claim 1, wherein the one of the plurality of funds comprises a holding fund, wherein the holding fund holds the predetermined monetary amount until a second predetermined monetary amount is reached and the second predetermined monetary amount is transferred to another of the plurality of funds.

10. The method of claim 1, wherein the assigning occurs responsive to a user selection of the one of the plurality of funds displayed in a user interface responsive to receipt of the predetermined monetary value at the deposit entity.

11. A system, comprising:
a processor;
a memory device that stores instructions executable by the processor to:
receive an indication of a purchase transaction by a user, wherein the purchase transaction comprises a purchase by the user from a retail entity and wherein the transaction is associated with a financial institution of the user;
transfer a predetermined monetary amount from the financial institution to an deposit entity, wherein the transferring comprises conducting a round-up transaction corresponding to the predetermined monetary amount and in conjunction with the purchase transaction; and
assign the predetermined monetary amount to one of a plurality of funds within the deposit entity, wherein the plurality of funds are chosen by the user and wherein the one of the plurality of funds is variable between purchase transactions.

12. The system of claim 11, wherein the predetermined monetary amount is determined based upon a monetary amount of the purchase transaction.

13. The system of claim 11, wherein the one of the plurality of funds is selected based upon an amount of risk identified by the user.

14. The system of claim 11, wherein each of the plurality of funds corresponds to a game played using the predetermined monetary amount.

15. The system of claim 14, wherein the game comprises a betting game and wherein playing the game comprises placing a bet utilizing the predetermined monetary amount within the betting game.

16. The system of claim 15, wherein the game is played upon receipt of the predetermined monetary amount and displayed within an application associated with the deposit entity.

17. The system of claim 11, wherein the deposit entity comprises a betting entity.

18. The system of claim 11, wherein the one of the plurality of funds comprises a holding fund, wherein the holding fund holds the predetermined monetary amount until a second predetermined monetary amount is reached and the second predetermined monetary amount is transferred to another of the plurality of funds.

19. The system of claim 11, wherein the assigning occurs responsive to a user selection of the one of the plurality of funds displayed in a user interface responsive to receipt of the predetermined monetary value at the deposit entity.

20. A product, comprising:
a storage device that stores code, the code being executable by a processor and comprising:
code that receives an indication of a purchase transaction by a user, wherein the purchase transaction comprises a purchase by the user from a retail entity and wherein the transaction is associated with a financial institution of the user;
code that transfers a predetermined monetary amount from the financial institution to an deposit entity, wherein the transferring comprises conducting a round-up transaction corresponding to the predetermined monetary amount and in conjunction with the purchase transaction; and
code that assigns the predetermined monetary amount to one of a plurality of funds within the deposit entity, wherein the plurality of funds are chosen by the user and wherein the one of the plurality of funds is variable between purchase transactions.
